(19) United States
(12) Patent Application Publication
(10) Pub. No.: US 2007/0081057 A1
(43) Pub. Date: Apr. 12, 2007

(54) Apparatus for measuring physical property of ink, inkjet printer including the same, and method of sensing ink state

(75) Inventors: Tae-Kyun Kim, Yongin-si (KR); Myung-song Jung, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/519,127

(22) Filed: Sep. 12, 2006

(30) Foreign Application Priority Data
Oct. 10, 2005 (JP) 10-2005-0094937

(51) Int. Cl. B41J 2/175

(52) U.S. Cl. 347/86

(57) ABSTRACT

A method and apparatus are provided for measuring a physical property of ink, the apparatus having a function of determining whether the ink is in an appropriate state for printing by monitoring a change of a physical property of the ink. The apparatus includes an ink storage unit, a printhead module, a physical property measuring unit, a storage unit, and a determination unit. The ink storage unit stores ink and the printhead module is connected to the ink storage unit to eject the ink onto a printing medium. The physical property measuring unit measures an actual value of the physical property of the ink (for example, electrical conductivity), and the storage unit stores a nominal value of the physical property of the ink, wherein the nominal value is determined in advance at a predetermined temperature. The determination unit compares the actual value with the nominal valued of the physical property of the ink and calculates an error therebetween to determine whether the error is within a predetermined error range.

### CROSS-REFERENCE TO RELATED PATENT APPLICATION

This application claims the benefit under 35 U.S.C. §119(a) of Korean Patent Application No. 10-2005-0094937, filed in the Korean Intellectual Property Office on Oct. 10, 2005, the entire disclosure of which is incorporated herein by reference.

### BACKGROUND OF THE INVENTION

1. Field of the Invention

The present invention relates to an inkjet printer. More particularly, the present invention relates to an apparatus for measuring a physical property of ink, an inkjet printer including the same, and a method of sensing an ink state by monitoring a change of physical property of ink, particularly, ink electrical conductivity, so as to optimize the use of ink in a printhead module.

2. Description of the Related Art

The use of ink in conventional inkjet printers results in a number of problems, including the following exemplary problems.

First, since changes of physical properties of ink are not considered, even when Qualified ink is used, it is difficult to perform a printing job when such changes occur.

For example, when an ink cartridge is not used for a long period of time, air flows in the ink cartridge through fine holes, thereby generating a variation in a residual amount of oxygen or nitrogen contained in ink. As a result, since air bubbles are generated within a printhead, the printhead or a system supplying ink to the printhead might malfunction.

Second, when ink used in an inkjet printer does not have proper printing characteristics, there is no way to inform a user of this. As a result, a printhead may be damaged by kogation, image quality may be reduced due to the entrance of air into the ink, and ink may be rapidly exhausted, so that the printhead may become severely overheated.

Third, since a process of determining whether ink has proper printing characteristics is not performed when an ink cartridge is refilled, improper ink may be used for printing.

Accordingly, a need exists for a system and method for measuring and evaluating a physical property of ink and informing a user of evaluation results to optimize printing.

### SUMMARY OF THE INVENTION

Embodiments of the present invention substantially solve the above and other problems and provide a method and apparatus for measuring a physical property of ink, an inkjet printer including the apparatus, capable of minimizing damage to a printhead or a system supplying ink to the printhead by measuring the ink's physical property change, particularly, the ink's electrical conductivity.

Embodiments of the present invention also provide an apparatus and method capable of preventing reduction of image quality or overheating of a printhead in advance by informing a user that inappropriate ink is used and taking proper measures.

According to an aspect of embodiments of the present invention, an apparatus is provided for measuring a physical property of ink, the apparatus comprising an ink storage unit for storing ink, a printhead module connected to the ink storage unit to eject the ink onto a printing medium including paper, a physical property measuring unit for measuring the ink's physical property, a storage unit for storing the ink's nominal physical property value at a predetermined temperature in advance, and a judgment unit for comparing the ink's nominal physical property value stored in the storage unit with the ink's physical property value measured by the physical property measuring unit to generate an error, and judging whether the error is within a predetermined error range.

One exemplary physical property of the ink is electrical conductivity.

The physical property measuring unit comprises a pair of probes disposed in an ink supply path between the ink storage unit and the printhead module, a reference signal applying part for applying a reference signal that measures the electrical conductivity of ink surrounding the probes, and an electrical conductivity calculator for calculating the electrical conductivity of the ink using a signal detected by the probes.

The determination unit informs a user that the ink is in an inappropriate state for printing when the error is not within the predetermined error range. For example, an exemplary error range comprises values within ±10% of the nominal physical property value stored in the storage unit.

According to another aspect of embodiments of the present invention, a method of sensing an ink state is provided, the method comprising measuring an ink's physical property when an ink cartridge is replaced, comparing the ink's measured physical property value with an ink's nominal physical property value at a predetermined temperature stored in advance to generate an error, and informing a user that the ink is in an appropriate state when the error is within the predetermined error range.

According to another aspect of embodiments of the present invention, a computer-readable medium is provided storing a computer program for executing a method of sensing an ink state, comprising instructions for measuring at least one of an ink's physical properties when an ink cartridge is replaced, comparing the ink's measured physical property value with the ink's nominal physical property value at a predetermined temperature stored in advance to generate an error, and informing a user that the ink is in an appropriate state when the error is within the predetermined error range.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 shows a block diagram of an apparatus for measuring an ink's physical property according to an exemplary embodiment of the present invention, and a terminal and monitor connected to the apparatus for use in measuring the ink's physical property;

FIG. 2 is a block diagram of a physical property (i.e., electrical conductivity) measuring unit comprising a pair of probes according to an exemplary embodiment of the present invention; and

FIG. 3 is a flowchart of a method of sensing an ink state according to an exemplary embodiment of the present invention.

Throughout the drawings, like reference numerals will be understood to refer to like parts, components and structures.

### DETAILED DESCRIPTION OF THE EXEMPLARY EMBODIMENTS

The present invention will now be described more fully with reference to the accompanying drawings, in which exemplary embodiments of the invention are shown. Like reference numerals in the drawings denote like elements, and thus their descriptions will not be repeated. The present invention may, however, be embodied in many different forms and should not be construed as being limited to the exemplary embodiments set forth herein; rather, these embodiments are provided so that this disclosure will be thorough and complete, and will fully convey the concept of the invention to those skilled in the art. Also, descriptions of functions or constructions well known to those skilled in the art will be omitted.

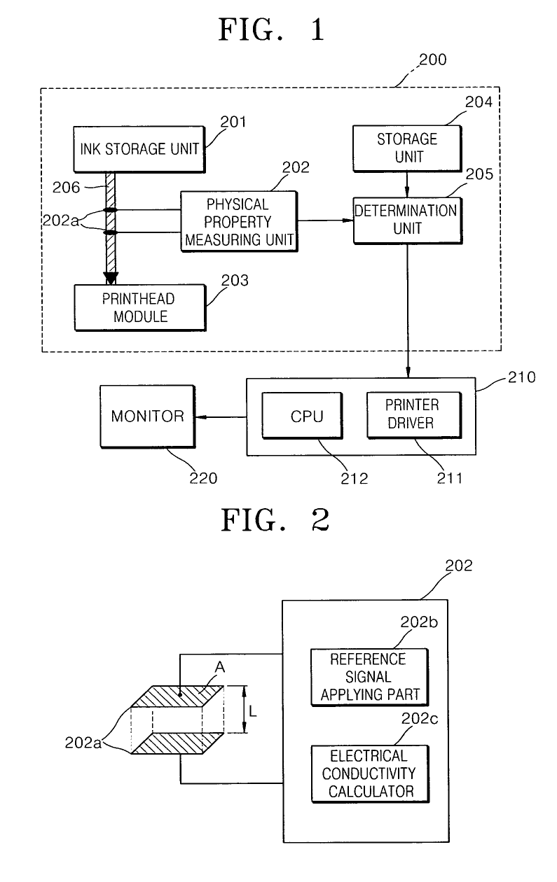

FIG. 1 shows a block diagram of an apparatus 200 for measuring an ink's physical property according to an embodiment of the present invention, and a terminal 210 and a monitor 220 connected to the apparatus for use in measuring the ink's physical property. Many physical properties of the ink can be measured, however, the case where the apparatus 200 measures the ink's electrical conductivity will be discussed as an exemplary embodiment of the present invention and will be described with reference to FIG. 1.

The apparatus 200 comprises an ink storage unit 201 and an ink supply path 206 through which ink is supplied to a printhead module 203. Also, the apparatus 200 further comprises a physical property measuring unit 202 and a pair of probes 202a disposed to span a predetermined distance of the ink supply path 206 between the ink storage unit 201 and the printhead module 203.

The ink's electrical conductivity can then be measured by applying an electrical signal to the ink using the pair of probes 202a and detecting a response signal thereto. The measured electrical conductivity is delivered to a determination unit 205 through a signal path from the physical property measuring unit 205, and compared with nominal values stored in a storage unit 204.

The storage unit 204 stores electrical conductivity nominal values of predetermined ink for predetermined temperatures. Table 1 shows by way of example, electrical conductivity values for representative inks currently on sale.

TABLE 1

| Manufacturing | | |
|---|---|---|
| Company | Model No. | Electrical conductivity (μs/cm) |
| Epson | MJIC5 | 4900 |
| | ICC25 | 1641 |
| | ICM25 | 984 |
| | ICBK25 | 719 |
| HP | C4836A | 5590 |
| | C4837A | 4010 |
| | C4838A | 6950 |
| | C4839A | 1334 |

Referring to Table 1, ink has an electrical conductivity ranging from about 719 μs/cm, which represents a relatively low value, up to about 6950 μs/cm, which is a relatively large value. From the above electrical conductivity values, it is revealed that ink has characteristic electrical conductivity depending on the kind of the ink for each manufacturing company. Also, since the electrical conductivity values are distributed over a wide range, there is only a small possibility that an error will be generated when the kind of ink is judged in an inkjet printer.

Although FIG. 1 illustrates only the apparatus 200 for measuring the ink's physical property, the apparatus 200 can be applied to any number of devices, such as an inkjet printer (not shown).

Also, although the ink storage unit 201 and the printhead module 203 are illustrated as separated from each other in FIG. 1, the two elements can be integrally formed. In this case, the pair of probes 202a can be located on the ink storage unit 201, and/or on the ink supply path 206 as in the exemplary embodiment of the present invention shown, to measure the ink's electrical conductivity.

FIG. 2 is a block diagram of the electrical conductivity measuring unit 202 comprising the pair of probes 202a according to an exemplary embodiment of the present invention. Referring to FIG. 2, the electrical conductivity measuring unit 202 comprises the pair of probes 202a, a reference signal applying part 202b, and an electrical conductivity calculator 202c.

An exemplary method of measuring the ink's electrical conductivity will now be conceptually described with reference to FIG. 2. Referring to FIG. 2, the pair of probes 202a are located to span a predetermined distance L on the ink supply path 206 illustrated in FIG. 1.

A reference signal (e.g., a voltage) for measuring the electrical conductivity is applied to the pair of probes 202a from the reference signal applying part 202b, and the electrical conductivity calculator 202c calculates electrical conductivity using a response signal (e.g., a current) to the reference signal. Such a measurement is based on the fact that when a predetermined voltage is applied to the pair of probes 202a immersed in ink, the applied voltage (V) allows a current (I) to flow and the amount of the flowing current depends on the electrical conductivity of the ink as represented by Equation (I) below.
V=I·R Equation 1
Specific resistance ρ(Ω·cm) is given by Equation 2 below,
ρ=R·A/L=V·A/(L·I) Equation 2
wherein ρ is the specific resistance (Ω·cm), L is a distance (cm) between the two probes, and A is the cross-sectional area (cm²) of the probes.

Therefore, from Equations 1 and 2,
σ((Ω·cm)−1)
which is electrical conductivity, is given by Equation 3 below.
σ=1/ρ=A/(ρ·I) Equation 3

Embodiments of the present invention describe a concept for measuring the electrical conductivity, and a variety of integrated sensors intended for measuring the electrical conductivity can be applied to implement the present invention.

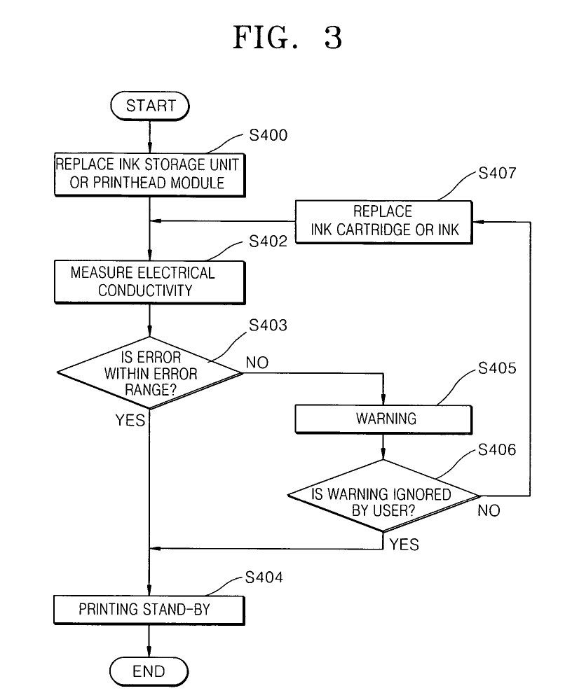

FIG. 3 is a flowchart of a method of sensing an ink state according to an exemplary embodiment of the present invention. The method of sensing the ink state according to embodiments of the present invention will now be described in detail with reference to FIGS. 1 through 3.

First, when an ink storage unit 201 or a printhead module 203 is replaced in operation S400, the physical property measuring unit 202 measures the electrical conductivity of the new ink in operation S402. Although the electrical conductivity is measured only when the ink storage unit or the printhead module is replaced according to an embodiment of the present invention, in yet other embodiments of the present invention, the electrical conductivity can be measured at any time, including (i) after an inkjet printer performs a printing operation of more than predetermined dots, or can be automatically measured at any time, including (ii) after a predetermined period of time elapses.

In operation S403, the determination unit 205 generates an error by comparing the measured electrical conductivity value with a nominal electrical conductivity value stored in the storage unit 204, and determines whether the error is within a predetermined error range. The error range can be, for example, values within ±10% of the nominal value stored in the storage unit 204.

As a result of the determination, when the error is within the predetermined error range, it is determined that the replaced ink is in an appropriate state for printing and a printing stand-by is performed in operation S404.

When it is determined that the error deviates from the error range in operation S403, a warning is given to a user so that the user can recognize such a state, i.e., replaced ink is in an inappropriate state for printing, in operation S405.

Such a warning can be displayed on a monitor 220 using a printer driver 211 of the terminal 210 from the determination made by the determination unit 205, or can be provided in the form of an audible warning to arouse a user's attention. The warning can be displayed through a display unit (not shown) of an inkjet printer itself that adopts the apparatus 200 for measuring the ink's physical property. It is also possible to inform the user of any other status that may cause a printing defect or damage to a printer using such a warning.

When a user ignores the warning in operation S406, the printing stand-by operation S404 is performed with the ink of an inappropriate state.

However, when a user receives the warning in operation S406, a user can choose to replace the ink storage unit or ink in operation S407. After the ink storage unit or the ink is replaced, a series of operations starting from operation S402 that measure the electrical conductivity is repeated again.

As described above, it is possible to minimize damage to a printhead or a system supplying ink to the printhead by measuring an ink's physical property change, particularly, an ink's electrical conductivity.

Also, it is possible to prevent reduction of image quality or overheating of a printhead by allowing an inkjet printer to judge whether inappropriate ink is being used.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An apparatus for measuring a physical property of ink, the apparatus comprising:
a physical property measurement, comparison and storage means having a function of determining whether the ink is in an appropriate state for printing by monitoring a change of the physical property of the ink.

2. The apparatus of claim 1, wherein the apparatus comprises:
an ink storage unit for storing ink;
a printhead module connected to the ink storage unit for ejecting the ink onto a printing medium;
a physical property measuring unit for measuring an actual value of the physical property of the ink;
a storage unit for storing a nominal value of the physical property of the ink, wherein the nominal value is determined in advance at a predetermined temperature; and
a determination unit for comparing the nominal value with the actual value of the physical property of the ink, calculating an error between the nominal value and the actual value of the physical property of the ink, and determining whether the error is within a predetermined error range.

3. The apparatus of claim 2, wherein the physical property of the ink comprises electrical conductivity.

4. The apparatus of claim 3, wherein the physical property measuring unit comprises:
a pair of probes disposed in an ink supply path between the ink storage unit and the printhead module;
a reference signal applying part for applying a reference signal to measure the electrical conductivity; and
an electrical conductivity calculator for calculating the electrical conductivity of the ink using a signal detected by the probes.

5. The apparatus of claim 2, wherein the determination unit is configured to inform a user that the ink is in an inappropriate state for printing when the error is not within the predetermined error range.

6. The apparatus of claim 2, wherein the error range comprises values within about ±10% of the nominal value of the physical property of the ink.

7. An inkjet printer, comprising:
an ink storage unit for storing ink;
a printhead module connected to the ink storage unit for ejecting the ink onto a printing medium;
a physical property measuring unit for measuring an actual value of the physical property of the ink, comprising a pair of probes disposed in an ink supply path between the ink storage unit and the printhead module, a reference signal applying part for applying a reference signal to measure the electrical conductivity, and an electrical conductivity calculator for calculating the electrical conductivity of the ink using a signal detected by the probes;
a storage unit for storing a nominal value of the physical property of the ink, wherein the nominal value is determined in advance at a predetermined temperature; and
a determination unit for comparing the nominal value with the actual value of the physical property of the ink, calculating an error between the nominal value and the actual value of the physical property of the ink, and determining whether the error is within a predetermined error range.

8. A method of sensing an ink state in an inkjet printer including an ink cartridge, the method comprising:
measuring an actual value of a physical property of ink when the ink cartridge is replaced;
comparing the actual value with a pre-stored nominal value of the physical property of the ink, and calculating an error between the actual value and the nominal value of the physical property of the ink; and
informing a user that the ink is in an appropriate state when the error is within a predetermined error range.

9. The method of claim 8, further comprising measuring the actual value of the physical property of the ink when the ink is replaced.

10. The method of claim 8, further comprising automatically measuring the actual value of the physical property of the ink after a predetermined period of time.

11. The method of claim 8, further comprising automatically measuring the actual value of the physical property of the ink after more than a predetermined amount of ink is consumed.

12. The method of claim 8, wherein the physical property of the ink comprises electrical conductivity.

13. The method of claim 8, wherein the error range comprises values within about ±10% of the nominal value of the physical property of the ink.

14. The method of claim 9, wherein the physical property of the ink comprises electrical conductivity.

15. The method of claim 10, wherein the physical property of the ink comprises electrical conductivity.

16. The method of claim 11, wherein the physical property of the ink comprises electrical conductivity.

17. A computer-readable medium storing a computer program for executing a method of sensing an ink state, comprising:
a first set of instructions for controlling a physical property measurement unit to measure at least one of an ink's physical properties;
a second set of instructions for controlling a determination unit to compare the ink's measured physical property value with an ink's nominal physical property value at a predetermined temperature stored in advance to generate an error; and
a third set of instructions to generate at least one of a message informing a user that the ink is in an appropriate state when the error is within the predetermined error range, and a message informing a user that the ink is in an inappropriate state when the error is outside the predetermined error range.

18. The computer-readable medium of claim 17, wherein the first set of instructions comprise:
a set of instructions to control a reference signal applying part to apply a reference signal to measure an electrical conductivity of the ink; and
a set of instructions to control an electrical conductivity calculator to calculate the electrical conductivity of the ink as the measured physical property value.

19. The computer-readable medium of claim 17, wherein the first set of instructions comprise:
a set of instructions to measure the actual value of the physical property of the ink when the ink is replaced;
a set of instructions to automatically measure the actual value of the physical property of the ink after a predetermined period of time; and
a set of instructions to automatically measure the actual value of the physical property of the ink after more than a predetermined amount of ink is consumed.

20. The computer-readable medium of claim 17, further comprising:
a set of instructions for storing the ink's nominal physical property value at a predetermined temperature in advance in a storage unit in communication with the determination unit.
